(19) United States
(12) Patent Application Publication
(10) Pub. No.: US 2005/0164720 A1
(43) Pub. Date: Jul. 28, 2005

(54) METHOD OF FILTERING MESSAGES WITH RECEIVING TELEPHONE APPARATUS

(76) Inventor: Yi-Hsiang Huang, Tao-Yuan Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/707,804

(22) Filed: Jan. 13, 2004

(51) Int. Cl. H04Q 7/20; H04M 11/00

(52) U.S. Cl. 455/466; 455/412.1

(57) ABSTRACT

A method of filtering messages received on a receiving telephone apparatus includes receiving a message from a calling telephone and applying filtering rules to the message. A first filtering rule includes filtering the message if a telephone number of the calling telephone contains less than a predetermined number of digits. If the message satisfies at least one of the filtering rules, a filtering process is then executed on the message.

### BACKGROUND OF INVENTION

1. Field of the Invention

The present invention relates to a method for filtering received messages, and more specifically, to a method for filtering Short Message Service (SMS) messages according to a telephone number of the calling telephone.

2. Description of the Prior Art

Along with the increased popularity of mobile phones has come an increase in the number of mobile phone users sending and receiving SMS messages. Unfortunately, mobile phones can only store a limited number of SMS messages on a Subscriber Identity Module (SIM) card. Because only a limited number of messages can be stored on the SIM card, it is possible that the SIM card may fill up with messages before a user of the mobile phone has a chance to delete old messages. If the SIM card is already full with SMS messages, the user will not be able to receive new SMS messages on the mobile phone or will not be able to keep the old messages in order to store new ones on the SIM card.

To make matters worse, increasing numbers of unsolicited advertisements are sent as SMS messages every day. These and other unwanted SMS messages cause burdens on users of mobile phones, and can quickly fill up the available space for SMS messages on SIM cards. A user of the mobile phone has to constantly manually delete the advertisements or risk filling up the SIM card with unwanted SMS messages.

### SUMMARY OF INVENTION

It is therefore a primary objective of the claimed invention to provide a method for filtering messages received on a receiving telephone apparatus in order to solve the above-mentioned problems.

According to the claimed invention, a method of filtering messages received on a receiving telephone apparatus is proposed. The method includes receiving a message from a calling telephone and applying filtering rules to the message. A first filtering rule includes filtering the message if a telephone number of the calling telephone contains less than a predetermined number of digits. If the message satisfies at least one of the filtering rules, a filtering process is then executed on the message.

It is an advantage of the claimed invention that the method can automatically filter out unwanted messages according to the filtering rules. In this way, a user of the receiving telephone apparatus does not have to manually filter out unwanted messages. Furthermore, the amount of space available for storing messages will not become full of unnecessary messages.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram of a receiving telephone receiving a message from a calling telephone through a telephone network.

FIG. 2 is a diagram of a message filtering menu used for filtering messages according to the present invention method.

FIG. 3 is a flowchart illustrating filtering received SMS messages with the receiving telephone according to the present invention method.

FIG. 4 is a flowchart illustrating filtering old SMS messages stored on the SIM card according to the present invention method.

### DETAILED DESCRIPTION

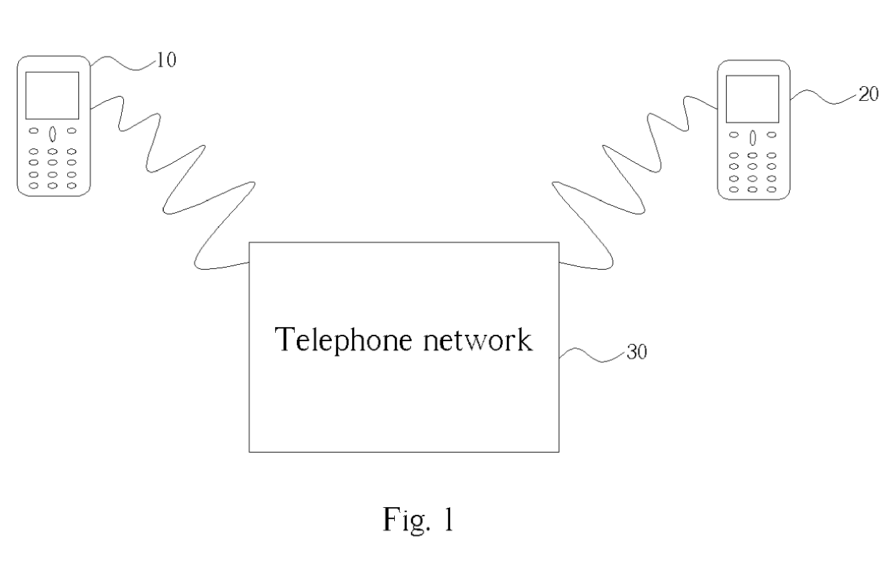

Please refer to FIG. 1. FIG. 1 is a diagram of a receiving telephone 10 receiving a message from a calling telephone 20 through a telephone network 30. For the sake of simplicity, the following disclosure will refer to the message being sent by the calling telephone 20 as a Short Message Service (SMS) message, although other kinds of messaging standards can also be used such as Enhanced Messaging Service (EMS) messages and Multimedia Messaging Service (MMS) The receiving telephone 10 is preferably a mobile telephone, but the present invention can also be implemented in any telephone that can receive SMS messages. The present invention provides a way to filter SMS messages received by the receiving telephone 10. In this method, any messages satisfying predetermined filtering criteria are filtered with a handling process that has been set.

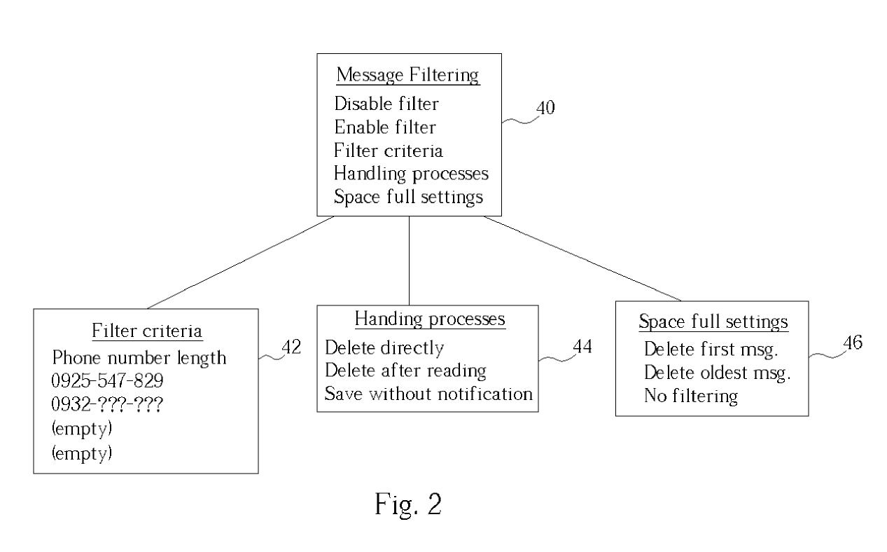

Please refer to FIG. 2. FIG. 2 is a diagram of a message filtering menu used for filtering messages according to the present invention method. A message filtering main menu 40 contains five menu choices that can be used to configure message filtering. First and second menu choices allow the message filtering to be disabled or enabled, respectively. Selecting a third menu choice enters a filter criteria sub-menu 42 for specifying the criteria used for filtering messages. Selecting a fourth menu choice enters a handling processes sub-menu 44 for specifying processes used to handle messages that satisfy the filtering criteria. Finally, selecting a fifth menu choice in the message filtering main menu 40 enters a space full settings sub-menu 46 for specifying actions taken when space used for storing SMS messages is full.

As shown in the filter criteria sub-menu 42, the present invention provides a variety of criteria that can be used to filter SMS messages received by the receiving telephone 10. First of all, users can filter messages according to the length of the phone number corresponding to the received SMS message. For example, if a number of digits in the received phone number is less than a predetermined minimum number of digits, the message will be filtered. Phone numbers can also be filtered if they exceed a maximum number of digits. This feature is useful for filtering out unsolicited advertisements. Often, advertisers will enter a fake phone number as their own phone number to avoid detection. Occasionally, the number entered will have a smaller number of digits than normal telephone numbers. This is a very good indication that the corresponding message is an unwanted message, such as unsolicited advertising. Suppose that a normal telephone number has 10 digits, such as “0934-987-324”. A user of the receiving telephone 10 can adjust the filtering criteria such that all messages having corresponding phone numbers with less than 7 digits will be filtered. Therefore, if an advertiser sends a message and uses a telephone number of “41288”, the message will be filtered.

In addition, the filter criteria sub-menu 42 allows specific phone numbers and phone numbers containing wildcards to be entered into a blocking list. When an SMS message is received from one of the phone numbers on the blocking list, it will be filtered if message filtering is enabled. For instance, entering “0925-547-829” in the blocking list would filter all messages from that specific phone number. A wildcard entry of “0932-???-???” would filter messages from all 10 digit phone numbers starting with the digits “0932”. Similarly, a wildcard entry of “0932*” would filter messages from all phone numbers beginning with the digits “0932”, regardless of the length of phone number. Of course, those familiar with wildcards realize that other wildcard filters are also possible. As shown in FIG. 2, the filter criteria sub-menu 42 provides additional empty fields for configuring additional filter criteria.

As shown in the handling processes sub-menu 44, the present invention provides three different processes that can be used for handling messages that satisfy the filtering criteria specified in the filter criteria sub-menu 42. A first process automatically deletes the unwanted SMS messages without alerting the user of the receiving telephone 10 with any audio, visual, or vibrating notifications. A second process automatically deletes the unwanted SMS messages after the user of the receiving telephone 10 has finished reading them. A third process automatically saves the unwanted SMS messages to the SIM card without alerting the user of the receiving telephone 10 that the messages have been received. Each of these three handling processes is designed to conveniently deal with messages that meet the filtering criteria while minimizing distractions to the user of the receiving telephone 10.

There are times when the SIM card in the receiving telephone 10 may become full of SMS messages, and cannot hold any additional SMS messages. For example, the SIM card of the receiving telephone 10 may only be able to store 10 SMS messages. In order to receive additional messages, space must first be created by deleting one or more existing messages. The space full settings sub-menu 46 allows a user to specify actions that can be taken to delete SMS messages to clear space when the SIM card is full. For instance, if one or more SMS messages in the SIM card meets the filtering criteria indicated in the filter criteria sub-menu 42, the first SMS message encountered will be deleted. On the other hand, the receiving telephone 10 can instead delete the oldest message meeting the filtering criteria. However, the user also has the choice of disabling the filtering of messages when the SIM card is full so that no saved messages will be deleted automatically.

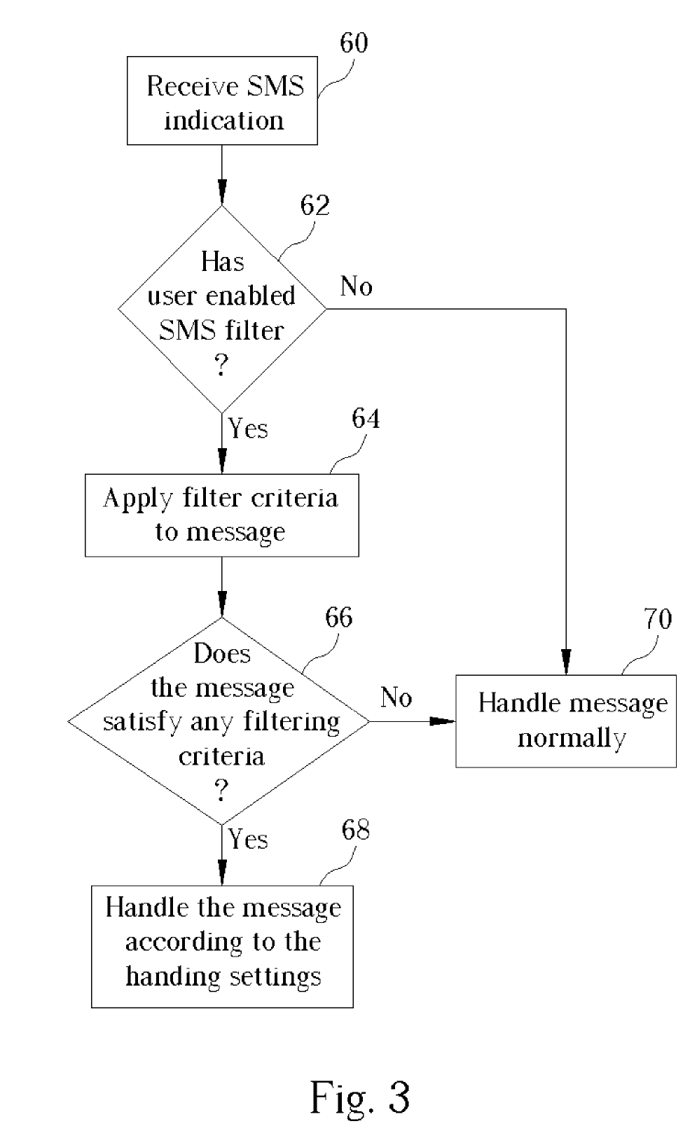

Please refer to FIG. 3. FIG. 3 is a flowchart illustrating filtering received SMS messages with the receiving telephone 10 according to the present invention method. Steps contained in the flowchart will be explained below.

Step 60: Receive an indication from the telephone network 30 that a new SMS message has been received by the receiving telephone 10;

Step 62: Determine if the user of the receiving telephone 10 has enabled the SMS message filter; if so, go to step 64; if not, go to step 70;

Step 64: Apply the filtering criteria stated in the filter criteria sub-menu 42 to the received SMS message;

Step 66: Determine if the received SMS message satisfies any of the filtering criteria; if so, go to step 68; if not, go to step 70;

Step 68: Handle the message according to the handling settings specified in the handling processes sub-menu 44; and

Step 70: Since the message is not to be filtered, handle the message normally, according to settings of the receiving telephone 10. Normal handling settings include storing the SMS message in the SIM card, while possibly generating an audio or visual alert.

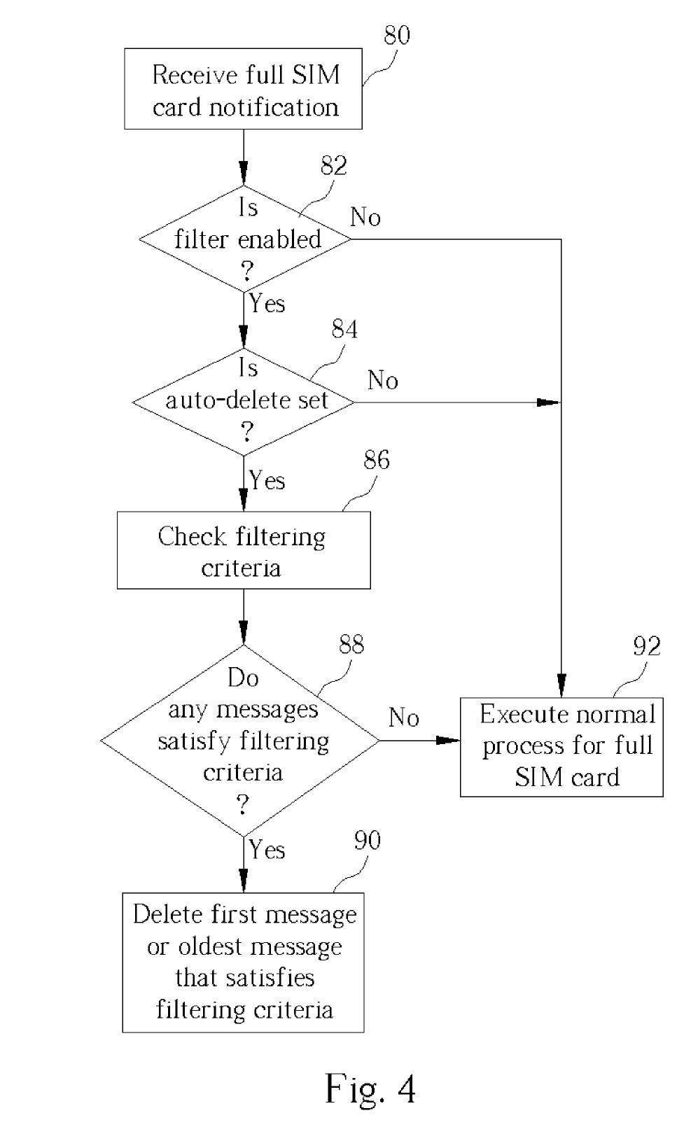

As shown in the space full settings sub-menu 46, the receiving telephone 10 can automatically delete old SMS messages stored on the SIM card to free up space for new messages. Please refer to FIG. 4. FIG. 4 is a flowchart illustrating filtering old SMS messages stored on the SIM card according to the present invention method. Steps contained in the flowchart will be explained below.

Step 80: The receiving telephone 10 receives a notification that the SIM card is full of SMS messages;

Step 82: Determine if the SMS message filter has been enabled (in the message filtering main menu 40); if so, go to step 84; if not, go to step 92;

Step 84: Determine if one of the automatic delete settings is enabled in the space full settings sub-menu 46 (delete first message or delete oldest message); if so, go to step 86; if not, go to step 92;

Step 86: Compare the messages stored in the SIM card with the filtering criteria specified in the filter criteria sub-menu 42;

Step 88: Determine if any of the messages stored in the SIM card satisfy any of the filtering criteria; if so, go to step 90; if not, go to step 92;

Step 90: Delete the first message come across in the SIM card or the oldest message stored in the SIM card, according to the settings of the space full settings sub-menu 46; and

Step 92: Since no messages are to be filtered, execute events normally triggered when the SIM card becomes full. Normally, an audio or visual alert will be given to alert the user of the receiving telephone 10 that the SIM card is full of SMS messages.

In contrast to the prior art, the present invention method provides a way to automatically deal with unwanted SMS messages through the use of a message filter. Users can filter messages based on the number of digits in the phone number corresponding to the message, set up a blocking list for blocking specific phone numbers, or block numbers using wildcards. While the filter may not be able to filter out all unsolicited messages, the present invention allows the user to have more control over what messages are received on the receiving telephone 10.

Those skilled in the art will readily observe that numerous modifications and alterations of the device may be made while retaining the teachings of the invention. Accordingly, the above disclosure should be construed as limited only by the metes and bounds of the appended claims.

1. A method of filtering messages received on a receiving telephone apparatus, the method comprising:
receiving a message from a calling telephone;
applying a filtering rule to the message on the receiving phone; and
executing a filtering process if the message satisfies the filtering rules.

2. The method of claim 1 wherein the filtering rule comprises filtering the message if the telephone number of the calling telephone contains less than a predetermined number of digits.

3. The method of claim 1 wherein the filtering rule comprises filtering the message if the telephone number of the calling telephone is not listed in a phone book of the receiving telephone apparatus.

4. The method of claim 1 wherein the filtering rule comprises filtering the message if the telephone number of the calling telephone is listed as an entry in a blocking list stored in the receiving telephone apparatus.

5. The method of claim 1 wherein a portion of at least one telephone number entry listed in the blocking list is specified as a wildcard, the filtering rule comprises filtering the message if the telephone number of the calling telephone matches the wildcard entry in the blocking list.

6. The method of claim 1 wherein executing the filtering process on the message comprises automatically deleting the message without informing a user of the receiving telephone apparatus.

7. The method of claim 1 wherein executing the filtering process on the message comprises automatically deleting the message after a user of the receiving telephone apparatus has finished reading the message.

8. The method of claim 1 wherein executing the filtering process on the message comprises saving the message to a Subscriber Identity Module (SIM) card of the receiving telephone apparatus without informing a user of the receiving telephone apparatus.

9. The method of claim 1 wherein if a Subscriber Identity Module (SIM) card of the receiving telephone apparatus is full with messages from calling telephones, the receiving telephone apparatus automatically deletes a first message that matches the filtering rule.

10. The method of claim 1 wherein if a Subscriber Identity Module (SIM) card of the receiving telephone apparatus is full with messages from calling telephones, the receiving telephone apparatus automatically deletes an oldest message that matches the filtering rule.

11. The method of claim 1 wherein the message is a Short Message Service (SMS) message.

12. A method of filtering messages received on a receiving telephone apparatus, the method comprising:
receiving a message from a calling telephone;
applying a filtering rule to the message; and
executing a filtering process on the message if the message satisfies the filtering rules, a first filtering process comprising automatically deleting the message without informing a user of the receiving telephone apparatus.

13. The method of claim 12 wherein the filtering rule comprises filtering the message if a telephone number of the calling telephone contains less than a predetermined number of digits.

14. The method of claim 12 wherein the filtering rule comprises filtering the message if the telephone number of the calling telephone is not listed in a phone book of the receiving telephone apparatus.

15. The method of claim 12 wherein the filtering rule comprises filtering the message if the telephone number of the calling telephone is listed as an entry in a blocking list stored in the receiving telephone apparatus.

16. The method of claim 15 wherein a portion of at least one telephone number entry listed in the blocking list is specified as a wildcard, and the filtering rule comprises filtering the message if the telephone number of the calling telephone matches the wildcard entry in the blocking list.

17. The method of claim 12 wherein a second filtering process comprises automatically deleting the message after a user of the receiving telephone apparatus has finished reading the message.

18. The method of claim 12 wherein a third filtering process comprises saving the message to a Subscriber Identity Module (SIM) card of the receiving telephone apparatus without informing a user of the receiving telephone apparatus.

19. The method of claim 12 wherein if a Subscriber Identity Module (SIM) card of the receiving telephone apparatus is full with messages from calling telephones, the receiving telephone apparatus automatically deletes a first message that matches the filtering rule.

20. The method of claim 12 wherein if a Subscriber Identity Module (SIM) card of the receiving telephone apparatus is full with messages from calling telephones, the receiving telephone apparatus automatically deletes an oldest message that matches the filtering rule.
